(19) United States
(12) Patent Application Publication
(10) Pub. No.: US 2010/0266690 A1
(43) Pub. Date: Oct. 21, 2010

(54) STABILIZER CONCENTRATE FOR MATRIX COMPOSITIONS PROCESSED AT ELEVATED TEMPERATURES

(76) Inventor: Joseph P. Bartko, Nazareth, PA (US)

Correspondence Address: INTERNATIONAL SPECIALTY PRODUCTS;WILLIAM J. DAVIS, ESQ., 1361 ALPS ROAD, WAYNE, NJ, 07470, US

(21) Appl. No.: 12/679,648

(22) PCT Filed: Oct. 2, 2008
(86) PCT No.: PCT/US08/78548

§ 371 Date: Jun. 14, 2010

Related U.S. Application Data
(60) Provisional application No. 60/977,184, filed on Oct. 3, 2007.

(51) Int. Cl. A01N 25/04; C08K 5/3417

(52) U.S. Cl. 424/484; 524/94

(57) ABSTRACT

A stabilizer concentrate of, by wt. (a) 5 to 50% of N-(trichloromethylthio)phthalimide, (b) 5-20% antioxidant, and optionally (c) a carrier component. The concentrate can be incorporated into a matrix composition, e.g., a plastic, and processed at temperatures up to 2800 C without degrading the biocide or discoloring the plastic.

### CROSS-REFERENCE TO RELATED APPLICATIONS

This application relates to U.S. patent application Ser. No. 10/893,008, filed Jul. 16, 2004, the disclosure of which is hereby incorporated by reference in its entirety.

### FIELD OF THE INVENTION

This invention relates to thermal stabilization of biocides present in a matrix composition processed at elevated temperatures, and, more particularly, to a stabilizer concentrate containing a heat resistant biocide and an antioxidant for incorporation into such matrix compositions.

### DESCRIPTION OF THE PRIOR ART

The use of an antioxidant to improve the thermal stability of plastics is well known in the art. However, when a biocide is introduced into such plastics, especially clear plastics, thermal degradation of the biocide occurs at the processing temperature of the plastic, which tends to discolor the plastic.

Accordingly, it is an object of this invention to provide a stabilizer concentrate for matrix compositions processed at elevated temperatures, thereby to preclude or reduce degradation of the biocide or discoloration of the matrix material.

### SUMMARY OF THE INVENTION

What is described herein is stabilizer concentrate including N-(trichloromethylthio)phthalimide, a heat-resistant biocide, an antioxidant and optionally a carrier therefore. The composition which can be processed at a temperature up to about 280° C., substantially without thermal degradation of the biocide or discoloration of the matrix.

### DETAILED DESCRIPTION OF THE INVENTION

The stabilizer concentrate of this invention comprises, N-(trichloromethylthio)phthalimide, an antioxidant and optionally a carrier. When the carrier is absent, the stabilizer concentrate preferably comprises by weight (a) 20 to 80% N-(trichloromethylthio)phthalimide and (b) 20 to 80% antioxidant. When the carrier is present, the stabilizer concentrate preferably comprises by weight 5-50% N-(trichloromethylthio)phthalimide, 5-20% antioxidant and the remainder comprising the carrier. In preferred embodiments, the concentrate can be in the form of a pellet, liquid or powder.

Preferably, in the stabilizer concentrate the wt. ratio of (a):(b) is about 1:0.5 to 1:3, for incorporation into a matrix. In a preferred embodiment, (a) is present in an amount of 10-20%. The carrier (c) can be a polyolefin, polyvinyl chloride, polyurethane, polyester, a wood-plastic composite, a polycarbonate, an elastomer, a rubber, an acrylic, or styrenic. In preferred embodiments, the carrier can be a plastic, wax or plasticizer. In a preferred embodiment, (c) is a plasticizer selected from diisononyl phthalate, diisodecyl phthalate, or butyl benzyl phthalate.

Preferably, the concentrate is incorporated into the matrix composition in a wt. ratio of 1 to 10 of concentrate to 99 to 10 of matrix. Most preferably, (b) is octadecyl-3 (3′,5′-di-tert. butyl-4-hydroxyphenyl) propionate or tris-(2,4-di-tert. butyl phenyl) phosphate.

The stabilizer concentrate of the invention is made by admixing components (a), (b) and (c), and extruding the mixture at a temperatures below the matrix composition processing temperature, thereby facilitating dispersion of the components. For example, when flexible PVC is used as matrix, a suitable carrier for the concentrate is ethylene vinyl acetate, which can be processed at about 120° C.

The wt. ratio of biocide to antioxidant in the concentrate of this invention can be optimized for different matrix materials in the product composition. For example, for a flexible PVC matrix, the preferred wt. ratio of the components is 20% biocide to 10% antioxidant. For an olefin matrix, the level of biocide in the concentrate preferably ranges from 5 to 30%. For a urethane matrix, this ratio is usually 5 to 25%. Wood-filled olefins are best processed with a concentrate of 20% Folpet®, 5% antioxidant and 75% low density polyolefin carrier. This particular concentrate suitably is extruded at an average melt temperature of 110° C. and cut into the form of pellets.

Suitable antioxidants for use herein include the following:
tetrabismethylene(3,5-di-t-butyl-4-hydroxyhydrocinnamate)methane;
octadecyl-3(3,5-di-t-butyl-4-hydroxyphenyl)propionate;
C13-C15 linear and branched alkyl esters of 3-propionic acid;
2,2-thioethylene bis propionate;
1,3,5-tris isocyanurate;
1,3,5-trimethyl-2,4,6-tris-benzene;
2,2-methylenebis phenol;
4,4-butylidenebis phenol;
2,2-isobutylidenebis phenol;
2,5-di-t-amylhydroquinone;
a,a,3-tris butane;
1,3,5-tris-1,3,5-triazone-2,4,6-trione;
polymeric sterically hindered phenol;
triethylene glycol bis propionate;
n,n-hexamethylene bis propionamide;
4,4-thiobis phenol;
2,2-methylenebis phenol;
1,2-bis hydrazine; or
tris phosphate bis pentaerythritol diphosphite.

Preferred antioxidants include sterically hindered phenols, amines, azoles, or aryl phosphates. Particularly preferred antioxidants include octadecyl-3(3′,5′-di-tert-butyl-4′-hydroxyphenyl)propionate (PP-18) and tris-(2,4-di-tert-butylphenyl)phosphate (Alkanox® 240).

All liquid plasticizer may be used as a carrier material when a liquid concentrate is desired, e.g. for flexible PVC matrix materials. Suitable liquid plasticizers include diisononyl phthalate, diisodecyl phthalate (DIDP) and butyl benzyl phthalate (BBP).

The antioxidant component itself suitably can function as a carrier for the biocide in the concentrate, e.g. in suitable wt. ratios of 25/75, 50/50 and 75/25.

The following examples further illustrate the invention.

### Example 1

20% Fungitrol®-11 (ISP) was mixed with 5% antioxidant (Alkanox® 240) and extruded into concentrate pellets using polyethylene plastic as a carrier resin. The average melt temperature was maintained at 110° C. Subsequently the concentrate was included in high density polyethylene (HDPE) and low melt flow polypropylene compositions and processed at 200° C. No degradation of the biocide was noted after this treatment.

### Example 2

10% Fungitrol-11 was mixed with 10% antioxidant and DIDP plasticizer. Silica was added to maintain a stable dispersion of the concentrate. The shelf life of the concentrate exceeded was in excess of 2-4 months. Subsequent testing of the concentrate in 70 durometer flexible PVC matrix showed no discoloration at 200° C. during a residence time of 15 minutes.

### Example 3

20% Fungitrol-11 was mixed with 75% ester type lubricant and 5% antioxidant. Subsequent extrusion into a wood filled polyethylene and wood filled polypropylene resulted in a stable extrusion into a board product.

### Example 4

A concentrate prepared of a 50/50 blend of Fungitrol-11 and antioxidant was mixed with polycarbonate plastic matrix and extruded into a flat sheet at 280° C. The product maintained the same transparency and clarity as a control sample with no biocide.

While the invention has been described with particular reference to certain embodiments thereof, it will be understood that changes and modifications may be made which are within the skill of the art.

What is claimed:

1. A stabilizer concentrate comprising by wt., (a) 5 to 50% N-(trichloromethylthio)phthalimide, (b) 5 to 20% antioxidant and (c) a carrier.

2. The stabilizer concentrate of claim 1 wherein said carrier is selected from the group consisting of a plastic, a wax or a plasticizer.

3. The stabilizer concentrate of claim 1 wherein said concentrate is in the form of a pellet, a liquid or a powder.

4. The stabilizer concentrate of claim 1 wherein the wt. ratio of (a):(b) is 1:0.5 to 1:3.

5. The stabilizer concentrate of claim 1 wherein (a) is present in an amount of 10-20% by wt.

6. The stabilizer concentrate of claim 1 wherein (b) is selected from the group consisting of a sterically hindered phenol, an amine, an azole, or an aryl phosphate.

7. The stabilizer concentrate of claim 1 wherein (c) is selected from the group consisting of a polyolefin, polyvinyl chloride, a polyurethane, a polyester, a wood-plastic composite, a polycarbonate, an elastomer, a rubber, an acrylic, or a styrenic.

8. The stabilizer concentrate of claim 1 wherein said concentrate is incorporated into a matrix in a wt. ratio of 1 to 10 concentrate to 99 to 10 matrix.

9. The stabilizer concentrate of claim 1 wherein (b) is octadecyl-3 (3′,5′-di-tertbutyl-4-hydroxyphenyl) propionate or tris-(2,4-di-tertbutyl phenyl) phosphate.

10. The stabilizer concentrate of claim 1 wherein (c) is a plasticizer selected from diisononyl phthalate, diisodecyl phthalate, or butyl benzyl phthalate.

11. A stabilizer concentrate comprising by wt., (a) 20 to 80% N-(trichloromethylthio)phthalimide and (b) 20 to 80% antioxidant.

12. A method of processing a biocide matrix composition at a temperature up to about 280° C., substantially without thermal degradation of the biocide or discoloration of the matrix comprising adding to said matrix the concentrate of claim 1.

13. A method of processing a biocide matrix composition at a temperature up to about 280° C., substantially without thermal degradation of the biocide or discoloration of the matrix comprising adding to said matrix the concentrate of claim 11.
